(19) United States
(12) Patent Application Publication
(10) Pub. No.: US 2013/0078401 A1
(43) Pub. Date: Mar. 28, 2013

(54) PACKAGING

(71) Applicant: Luen Sing TANG, Tsuen Wan (HK)

(72) Inventor: Luen Sing TANG, Tsuen Wan (HK)

(21) Appl. No.: 13/628,597

(22) Filed: Sep. 27, 2012

Related U.S. Application Data
(63) Continuation-in-part of application No. PCT/CN2011/080176, filed on Sep. 26, 2011.

(51) Int. Cl. B65D 65/28; B65D 33/16; B65D 43/02; B32B 1/02

(52) U.S. Cl. 428/34.1; 428/43; 383/209; 220/266; 383/204

(57) ABSTRACT

The present invention relates to a front sheet for packaging, the front sheet comprising a laminate of an inner layer and an outer layer relative to the interior of the packaging. The inner layer incorporates a removable strip having longitudinal edges abutting adjacent panels of the inner layer. Removal of the removable strip forms an opening through the inner and outer layers of the front sheet. An overlay sheet overlays and is substantially in contact with the removable strip. An improved product can thereby be produced. The invention also relates to containers and bags formed using a front sheet as described, and methods of manufacturing and filling and sealing such containers and bags.

### FIELD OF THE INVENTION

The present invention relates to packaging, and in particular to front sheets for packaging, containers and bags. The present invention also relates to containers and bags themselves, and to methods of forming bags and methods of packaging containers.

### BACKGROUND OF THE INVENTION

Current bags are known from, for example, U.S. Pat. No. 6,610,338, which have a multilayered sheet of flexible material including an inner layer and an outer layer relative to the interior of the bag, the inner layer comprising two unconnected pieces with substantially abutting adjacent edges, and the outer layer being substantially intact in the area of the abutting sections of the first layer, the bag thereby exhibiting a line of weakness defined by the interface of the two pieces along which the outer layer is tearable. Such bags can be torn along the lines of weakness to open the bag. Such bags do not comprise a removable strip for opening the bag. In addition, once the bag is torn to open, a part of the bag, usually the upper part, is removed and the “opened” bag is no longer of the same size and outlook as the original bag.

Laminated sheets for packaging materials are known from, for example, WO 2009/086604, which include first, second and third layers of flexible material which are bonded together, wherein the third layer includes a strip of a different material to the material of the remainder of the third layer, said different material being less heat bondable to other materials than the material of the remainder of the third layer, wherein at least one of the first, the second and the third layers of flexible material comprises a non-permeable material. Such materials can be used to manufacture flexible bags, which, due to the weak bonding of the strip to the third layer, provide a rupturable join for venting the bag under microwave heating. A problem with the laminated sheets of WO 2009/086604 is that the internal surface of the strip of a different material is not covered.

It is an aim of the invention to address the aforementioned problems.

### SUMMARY OF THE INVENTION

In view of the foregoing, there is provided, in a first aspect, a front sheet for packaging, the front sheet comprising a laminate of an inner layer and an outer layer relative to the interior of the packaging;
said inner layer incorporating a removable strip having longitudinal edges abutting adjacent panels of the inner layer;
arranged such that removal of said removable strip forms an opening through the inner and outer layers of said front sheet,
wherein an overlay sheet overlays and is substantially in contact with the removable strip.

Removal of the removable strip enables content enclosed in whole or in part by packaging material formed using the front sheet to be accessed. The abutting lines of the longitudinal edges of the removable strip against adjacent panels enable easy removal of the strip.

The overlay sheet of the present front sheet reduces the likelihood of the strip opening accidentally in use, especially if the overlay sheet is sealed to the front sheet, and particularly if the overlay sheet is bonded from a side of the front sheet that forms the opening of a bag formed using the front sheet, but not beyond the removable strip.

In one embodiment, said overlay sheet and said front sheet are heat sealable together at a temperature, and at said temperature said removable strip does not heat seal to said overlay sheet or said adjacent panels.

In another embodiment, the front sheet further comprises a reseal component, wherein a first part of said reseal component is attached to said front sheet and a second part of said reseal component is attached to said overlay sheet. In use of the present sheet in a bag or container, a reseal component may resealably close the opening formed by lifting the removable strip. The presence of an overlay sheet enables a reseal component to be fixed between the overlay sheet (as opposed to a back sheet) and the front sheet and therefore avoids having to fill the content of a bag formed of the front sheet by opening the reseal component, or having to fill the content from a bottom of such a bag (in which case it would be difficult to provide an optional bottom gusset to a bag). Preferably, the reseal component is closed during manufacture when it is attached to, for example, the front and overlay sheets. In one embodiment, the reseal component may be attached by heat sealing. In a further embodiment, this step may be followed by sealing the top part of the overlay sheet to the front sheet.

In an embodiment of front sheet comprising a reseal component, the reseal component may serve as a gate to the content of a bag or container formed from using said front sheet. Removal of the strip enables access to the content through the gate (i.e., through the reseal component which can be opened and re-closed), while the filling in of content may be between the overlay sheet and the front sheet. In one embodiment, the overlay sheet and the front sheet may be sealed after the filling in of content.

In one embodiment, the reseal component comprises a grip seal tape, in particular, a re-closable tape having a male fastener and a female fastener that are engageable by pressure towards each other.

In one embodiment, the grip seal tape is preferentially openable from one side. In one embodiment, a grip seal tape comprises a male part and a female part. In one aspect, a grip seal tape preferentially openable from one side may prevent opening of the grip seal tape from the internal side of a bag in which the present front sheet is used. Grip seal tapes which are preferentially openable from one side are known in the art and the design of the grip seal tape is such that opening from one side is more difficult than opening from the opposite side. In a bag or container formed using the front sheet of the present invention, such a grip seal tape may be attached to the front sheet and the overlay sheet and allow content to be filled in on the more difficult side to open, without the risk of the grip seal tape being opened easily from the more difficult side, which would cause leakage of content.

In one embodiment, bags comprising a reseal component may remain essentially intact after removal of the removable strip and access to the content can be closed by closing the reseal component.

In one embodiment, the removable strip comprises a tongue for facilitating lifting of the removable strip, wherein the tongue is formed by a cut through the front sheet.

In a specific embodiment, the tongue is omega-shaped such that the removable strip is provided with a head for lifting the strip.

In particular, the tongue may be provided by punching an omega-shaped portion through the front sheet.

In one embodiment, the overlay sheet comprises cast polypropylene (CPP). In another embodiment it may be a laminate of three layers:
(i) a first layer comprising CPP or polyethylene (PE);
(ii) a third layer comprising CPP or PE; and
(iii) a second layer comprising polyethylene terephthalate (PET) or oriented polypropylene (OPP) oriented polypropylene, between the first layer and the third layer.

In one aspect, the overlay sheet material is selected in order to ensure that at a pre-determined temperature, the removable strip is not heat sealable with the overlay sheet (or its adjacent panels), while the adjacent panels are heat-sealable with the overlay sheet and optionally any back sheet or container.

In one embodiment, the overlay sheet is perforated with one or more perforation. In one aspect, the perforations are arranged such that gas may escape through said perforations when the removable strip is removed. The perforations may allow venting when a bag or container formed from the present front sheet filled with content is heated in a microwave oven. In embodiments wherein a reseal component is present, such perforations may be arranged such that gas may escape from a bag or container formed from the present front sheet through said perforations when the removable strip is removed and the reseal component is closed.

In one embodiment, the overlay sheet has a slit or a long narrow opening. Preferably, the slit runs substantially parallel to the longitudinal edges of the removable strip, and is located between the two longitudinal edges of the removable strip. In particular, the overlay sheet may be bonded or laminated to the front sheet except at least for the region where the removable strip is located.

The present invention also provides a bag comprising a front sheet of the present invention, further comprising a back sheet wherein the front sheet and the back sheet define a bag having an internal cavity between the front sheet and the back sheet, and a goods or content opening. In a particular embodiment, said front sheet and said back sheet are attached at one or more regions through one or more folded gusset sheets, arranged such that the cavity between the front sheet and the back sheet is expandable by unfolding said gusset sheet. A gusset at the bottom of a bag may enable the bag to stand up after the bag is filled with goods or other content. In another embodiment, a cubic bag may be formed by folded gusset sheets, including side gussets inserted between the front sheet and the back sheets and heat sealed at the edges. A cubically shaped bag is shown in FIG. 7 of U.S. Pat. No. 7,597,480.

Said bag may remain essentially intact after removal of the removable strip.

In an alternative aspect, the present invention provides a container comprising a front sheet, the front sheet comprising a laminate of an inner layer and an outer layer relative to the interior of the container;
the inner layer incorporating a removable strip having longitudinal edges abutting adjacent panels of the inner layer,
arranged such that removal of said removable strip forms an opening through the inner and outer layers of said front sheet,
wherein an inner surface of the removable strip is temporarily bonded to a further component of the container, such that the bond is broken on removal of said removable strip.

In a particular embodiment, a certain degree of adhesion of the removable strip may result from heat sealing operation(s). In another aspect, before lamination to the outer layer, the strip may be coated with easy-open or peelable adhesives on the side facing the further component of the container, which may be, for example, an overlay sheet or a back sheet, to enable the strip to be able to be manually lifted but at the same time adhered to a certain degree to the further component forming a temporary bond.

In one aspect, the container further comprises a back sheet wherein the front sheet and the back sheet define a bag comprising an internal cavity between the front sheet and the back sheet, and a goods or content opening.

In one particular aspect, the front sheet and the back sheet are attached at one or more regions through one or more folded gusset sheets, arranged such that the cavity between the front sheet and the back sheet is expandable by unfolding said gusset sheet.

In one further embodiment, the back sheet and the front sheet are heat sealable together at a temperature, and at said temperature said removable strip does not heat seal to said back sheet or said adjacent panels.

In another embodiment, the container further comprises a reseal component, wherein a first part of said reseal component is attached to said front sheet and a second part of said reseal component is attached to said back sheet. In use, such a reseal component may resealably close the opening formed by lifting or removing the removable strip.

In one embodiment, the reseal component comprises a grip seal tape, in particular, a grip seal tape preferentially openable from one side.

In a further embodiment, said front sheet and said back sheet of a container are heat sealable for sealing said container.

In another aspect of the container, the removable strip comprises a tongue for facilitating lifting of the removable strip; and
wherein said tongue is formed by a cut through the front sheet.

In another aspect of the container, the tongue is omega-shaped such that the removable strip is provided with a head for lifting the strip.

In another aspect of the container, said cut extends to an edge of the front sheet.

In another aspect, the container further comprises a back sheet wherein the front sheet and the back sheet define a bag comprising an internal cavity between the front sheet and the back sheet, and a goods or content opening; and wherein an overlay sheet overlays and is temporarily bonded to said removable strip.

In one embodiment, the overlay sheet has a slit or a long narrow opening through which the internal cavity is accessible after removal of said removable strip. Preferably, the slit runs substantially parallel to the longitudinal edges of the removable strip, and is located between the two longitudinal edges of the removable strip. In particular, the overlay sheet may be bonded or laminated to the front sheet except at least for the region where the removable strip is located.

In one embodiment, the front sheet is attached to and closes a box.

In one aspect, the temporary bond is formed by a peelable adhesive or a peelable heat seal adhesive. Such an adhesive may keep the tongue in an adhered state. An adhered state may prevent leakage through a tongue in the strip before the removable strip is removed in embodiments such as where there is no reseal component. The adhesive may also help keep the strip in an aesthetically more pleasing smooth appearance, in particular, avoiding a wrinkled appearance if the strip is not bonded to an overlay sheet or back wall.

There is also provided a bag comprising a front sheet, the front sheet comprising a laminate of an inner layer and an outer layer relative to the interior of the container;
said inner layer incorporating a removable strip having longitudinal edges abutting adjacent panels of the inner layer;
arranged such that removal of said removable strip forms an opening through the inner and outer layers of said front sheet;
further comprising a back sheet, and an overlay sheet arranged between said front sheet and said back sheet;
wherein the front sheet and the back sheet define a bag having an internal cavity between the front sheet and the back sheet, which is accessible between the overlay sheet and the back sheet, and between the overlay sheet and the front sheet.

In a particular embodiment of the bag, the back sheet, the overlay sheet and the front sheet are heat sealable together at a temperature to seal said bag, and at said temperature the removable strip does not heat seal to said overlay sheet or said adjacent panels.

In a particular embodiment, the bag further comprises a reseal component arranged to close resealably an opening between the overlay sheet and the front sheet, wherein a first part of said reseal component is attached to the front sheet and a second part of said reseal component is attached to the overlay sheet. The reseal component may be arranged to resealably close the opening formed by lifting the removable strip.

In one aspect, the reseal component comprises a grip seal tape, in particular, a grip seal tape preferentially openable from one side.

In one aspect of the bag, the removable strip comprises a tongue for facilitating lifting of the removable strip;
wherein said tongue is formed by a cut through the front sheet.

Tongues may be formed by punching through the back sheet of a bag, in addition to the front sheet. However, such cuts must be made within a region of the front sheet to be sealed to a back sheet, in order to avoid an opening through which the contents may leak. Advantageously, the back sheet of the present bag may remain intact and leakage prevented by a reseal component. In bags comprising a reseal component, the bag has the advantage that the tongue does not need to stay within a side seal, but can be intermediate of two side seals without risk of leakage.

In one aspect of the bag, the tongue is omega-shaped such that the removable strip is provided with a head for lifting the strip.

In one aspect of the bag, the cut extends to an edge of the front sheet.

In one aspect of the bag, the tongue is omega-shaped such that the removable strip is provided with a head for lifting the strip.

In one aspect of the bag, said front sheet and said back sheet are attached at one or more regions through one or more folded gusset sheets, arranged such that the cavity between the front sheet and the back sheet is expandable by unfolding said gusset sheet.

In one aspect of the bag, the overlay sheet comprises CPP or is a laminate of three layers:
(i) a first layer comprising CPP or PE;
(ii) a third layer comprising CPP or PE; and
(iii) a second layer comprising PET or OPP, between the first layer and the third layer.

In one aspect of the bag, the overlay sheet is perforated.

In one aspect of the bag having a reseal component, the overlay sheet is perforated with one or more perforation such that gas may escape through said perforations when the removable strip is removed and a reseal component is closed. Such perforations may be exposed after the removable strip has been removed.

In one aspect the bag further comprises content such as goods in the bag, and the bag is sealed such that removal of the removable strip allows access to the contents of the bag.

In one embodiment, the overlay sheet has a slit or a long narrow opening through which the content of the bag is accessible after removal of the removable strip. Preferably, the slit runs substantially parallel to the longitudinal edges of the removable strip, and is located between the two longitudinal edges of the removable strip. In particular, the overlay sheet may be bonded or laminated to the front sheet except at least for the region where the removable strip is located.

There is also provided a method of forming a bag comprising:
i) forming a front sheet, the front sheet comprising a laminate of an inner layer and an outer layer relative to the interior of the bag, said inner layer incorporating a removable strip having longitudinal edges abutting adjacent panels of the inner layer,
arranged such that removal of said removable strip forms an opening through the inner and outer layers of said front sheet;
ii) applying an overlay sheet over the removable strip, wherein said overlay sheet overlays and is substantially in contact with the removable strip; and
iii) bonding the front sheet and the overlay sheet to a back sheet, such that the sheets define a bag having an internal cavity between the front sheet and the back sheet, which is accessible between the overlay sheet and the back sheet, and between the overlay sheet and the front sheet.

There is also provided a method of packaging a container comprising:
i) forming a front sheet, the front sheet comprising a laminate of an inner layer and an outer layer relative to the interior of the bag, said inner layer incorporating a removable strip having longitudinal edges abutting adjacent panels of the inner layer,
arranged such that removal of said removable strip forms an opening through the inner and outer layers of said front sheet;
ii) applying an overlay sheet over the removable strip, wherein said overlay sheet overlays and is substantially in contact with the removable strip; and
iii) bonding the front sheet and the overlay sheet over an opening in a container, such that an internal cavity is defined which is accessible between said overlay sheet and said container and between said overlay sheet and said front sheet.

In one embodiment, the method further comprises attaching a first part of a reseal component to the front sheet and a second part of said reseal component to the overlay sheet. The reseal component may resealably close the opening formed by removal of the removable strip.

There is further provided a method of packaging a container comprising:
i) forming a front sheet, the front sheet comprising a laminate of an inner layer and an outer layer relative to the interior of the bag, said inner layer incorporating a removable strip having longitudinal edges abutting adjacent panels of the inner layer,
arranged such that removal of said removable strip forms an opening through the inner and outer layers of said front sheet;
ii) applying an overlay sheet over the removable strip, wherein said overlay sheet overlays and is substantially in contact with the removable strip; and
iii) bonding the front sheet and the overlay sheet over an opening in a container, such that an internal cavity is defined which is accessible between said overlay sheet and said front sheet.

In another aspect, there is provided a use, in a method of sealing a container, of a front sheet as described.

In a further aspect, a method of sealing goods or other content within a bag is provided, the bag incorporating a front sheet as described, the bag further comprising a back sheet attached to said front sheet, such that a bag is defined comprising: an internal cavity between the front sheet and the back sheet, and a goods or content opening;
the method comprising sealing the front sheet to the back sheet across said goods or content opening.

In one embodiment, the method of sealing goods content within a bag or container comprises sealing the front sheet to the back sheet across said goods or content opening.

In further embodiments, the removable strip comprises one or more materials selected from: metallic foil, polyethylene terephthalate, paper and a fabric. The removable strip (which can be multi-layered) can comprise any material that is flexible and not broken when being removed, for example, by lifting and pulling.

Advantageously, such materials prevent sealing the strip to an overlay sheet (if present), a back sheet (if present) or the adjacent panels at a temperature used to seal an overlay sheet (if present), a back sheet (if present) or the adjacent panels; although, some degree of bonding may occur. For example, metallic foil and polyethylene terephthalate are not heat sealed to a CPP overlay sheet at a temperature used to seal the overlay sheet to the front sheet.

In alternative embodiments, the removable strip is multilayered and comprises a metallic foil layer and one or more other layers comprising one or more materials selected from: polyethylene terephthalate, nylon and oriented polypropylene.

In alternative embodiments, the removable strip may comprise aluminium foil.

In further embodiments, the outer layer of the front sheet is a film or composite film comprising one or more materials selected from oriented polypropylene, nylon and polyethylene terephthalate.

In another aspect, the panels of the inner layer which abut the removable strip comprise one or more materials selected from cast polypropylene (CPP) and polyethylene (PE). It is to be understood that the panels of the inner layer which abut the removable strip do not need to be of the same material and may be formed of different materials.

In one embodiment, the back sheet, if present, comprises a laminate of an outer layer of OPP or PET, and an inner layer of CPP or PE. In another embodiment, the back sheet, if present, comprises a CPP layer.

In another aspect, the thickness of the panels of the inner layer which abut the removable strip is greater than or equal to the thickness of the removable strip. If the removable strip is thicker than the adjacent panels, undesirable bulging may occur at its location when the laminate forming the front sheet is supplied from, for example, a reel during manufacture.

In another aspect, the removable strip extends across the front sheet from an attached region of a side of the sheet to a further attached region of another side of the sheet. The removable strip may therefore extend from one region at the edge of the bag to another edge allowing removal of the strip across the width of the bag.

In another aspect, said outer layer of said front sheet is provided with one or more lines of weakness adapted to facilitate tearing of said front sheet along one or more lines corresponding to the edges of the removable strip when the removable strip is removed, wherein said one or more lines of weakness are formed by one or more indentations, one or more broken lines or one or more lines of perforations in said outer layer. In such embodiments, the outer layer of the front sheet does not need to be intact, and also does not need to be easily tearable. For example, the outer layer may be laser cut (or perforated) with broken (or perforated) lines corresponding (or close) to the longitudinal edges of the removable strip. There may be only one broken or perforated line which is close to (for example intermediate of) both longitudinal edges of the removable strip. Such broken or perforated line(s) may enable opening of the outer layer of the front sheet when the removable strip is removed.

The present invention will now be described by way of example with reference to the accompanying drawings, in which:

### BRIEF DESCRIPTION OF THE DRAWINGS

FIG. 1 shows an exploded view of a cross-section of a front sheet according to one embodiment of the present invention;

FIG. 2 shows an exploded view of a cross-section of a front sheet further comprising an overlay sheet and further comprising a back sheet according to one embodiment of the present invention;

FIG. 3 shows a front view of a bag according to one embodiment of the present invention;

FIG. 4 shows a schematic side view of the bag of FIG. 3, along the line AA;

FIG. 5 shows a view similar to FIG. 4, but wherein the bag has been subjected to heat sealing operations;

FIG. 6 shows a view similar to FIG. 4 or FIG. 5, but wherein the bag has been subjected to heat sealing or further heat sealing operations;

FIG. 7 shows a view similar to FIG. 6, but with an exit route identified;

FIGS. 8a and 8b show an enlargement of an exploded view of a region of a bag of the type shown in FIG. 4 which has been subjected to heat sealing operations;

FIG. 9 shows a front view of a bag according to a further embodiment of the present invention;

FIG. 10 shows an exploded view of the bag of FIG. 9, along the line AA;

FIG. 11 shows a container to which a front sheet of the invention is applied;

FIG. 12 shows part of a front sheet according to the invention with an omega shaped hole forming a tongue;

FIG. 13 shows an enlargement of the tongue shown in the bags of FIGS. 3 and 9;

FIGS. 14a and 14b show an example of a bag according to one embodiment of the present invention; and

FIG. 15 shows a front view of a bag according to an embodiment of the present invention.

### DETAILED DESCRIPTION OF PREFERRED EMBODIMENTS

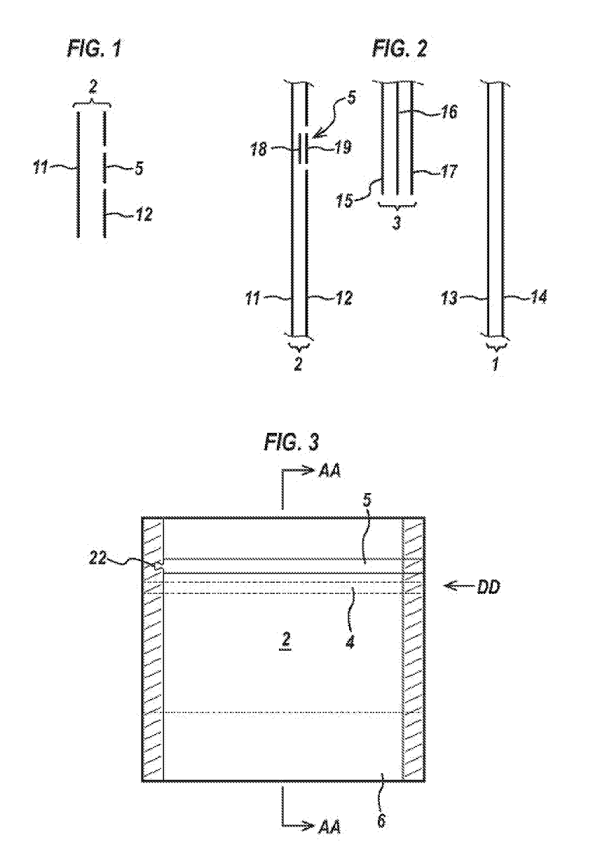

An example of a front sheet according to the present invention is depicted in FIG. 1, which shows a removable strip 5, an inner layer 12 and an outer layer 11. Layers 11 and 12 are laminated to each other to form the front sheet 2.

An example of a front sheet of FIG. 1 further comprising an overlay sheet and further comprising a back sheet is depicted in FIG. 2, which shows a removable strip 5 comprising a layer 18 and an optional layer 19. If layer 19 is present, layers 18 and 19 are laminated to each other to form the removable strip 5. The optional back sheet 1 is shown comprising an optional outer layer 14 and an inner layer 13 which are laminated to each other. The overlay sheet 3 is shown comprising three layers 15, 16 and 17 laminated to each other. Optionally, only layer 15 forms overlay sheet 3. The removable strip 5 has an inner surface which faces the outer surface of the overlay sheet 3. The removable strip 5 is not bonded to the overlay sheet 3 or is only temporarily bonded to the overlay sheet 3 by, for example, a peelable adhesive or a peelable heat seal adhesive.

In an alternative embodiment wherein the overlay sheet is not present, the strip 5 may be temporarily bonded to the back sheet 1.

An example of a bag of the present invention is depicted in FIG. 3, which shows a front sheet 2 heat sealed on its left and right sides to a back sheet 1 (back sheet 1 is behind sheet 2 in FIG. 3). An optional folded gusset sheet 6 is shown at the bottom of the bag and is heat sealed between sheets 1 and 2 along each of the sides and across the bottom. An overlay sheet 3 may be present which would be behind front sheet 2 in FIG. 3. A reseal component such as a grip seal tape 4 is also shown, the male and female parts of which are attached (by heat sealing) to the overlay sheet and the front sheet (or vice versa, in an alternative embodiment). The overlay sheet 3 extends from the left edge of the bag to the right edge of the bag and extends from the top of the bag to a region slightly beyond the grip seal tape 4. In alternative embodiments where an overlay sheet is not present, overlay sheet 3 is replaced by back sheet 1.

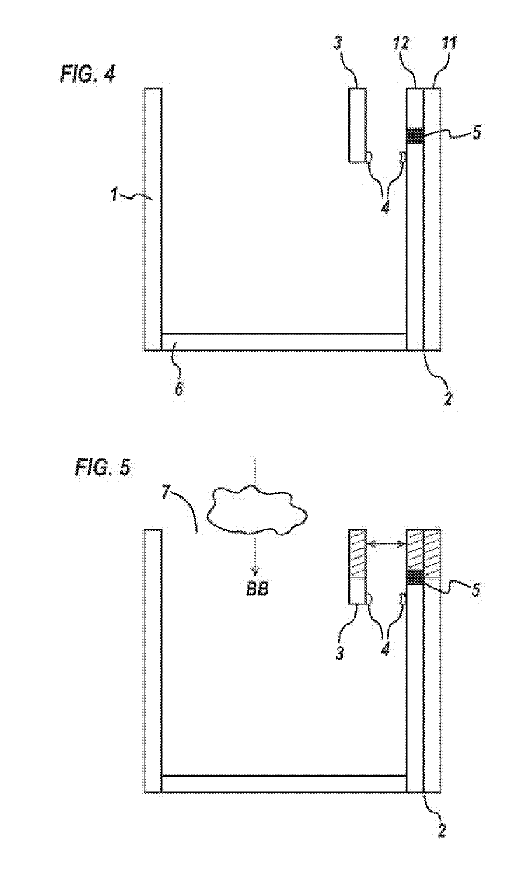

FIG. 4 shows an exploded view of the bag of FIG. 3 along the line AA, looking from the left of FIG. 3. The laminated front sheet 2 formed from outer layer 11 and inner layer 12 is shown. The gusset 6 is shown heat sealed to the back sheet 1 and the front sheet 2. A grip seal tape 4 is also shown, the male and female parts of which are attached (by heat sealing) to the overlay sheet 3 and the front sheet 2 (or vice versa, in an alternative embodiment).

An example of a bag of the present invention according to FIG. 4 is depicted in FIG. 5, showing a mouth region 7 and a direction BB in which content may be inserted into the bag. The content can be goods, solid, fluid or other items to be stored, saved or retained in the bag. The male part of reseal component 4 is heat sealed to overlay sheet 3 and the female part heat sealed to the front sheet 2. The overlay sheet 3 is attached by heat sealing to the front sheet 2 at the shaded region. The region of attachment between front sheet 2 and overlay sheet 3 overlaps, but does not extend beyond the removable strip 5. The grip seal tape 4 is shown open, but is closed during manufacture when it is attached to the front sheet and overlay sheet. This step is followed by sealing the top part of the overlay sheet to the front sheet as shown in FIG. 5. As illustrated by direction BB in FIG. 5, a mouth region 7 is bounded by the back sheet 1 and the overlay sheet 3.

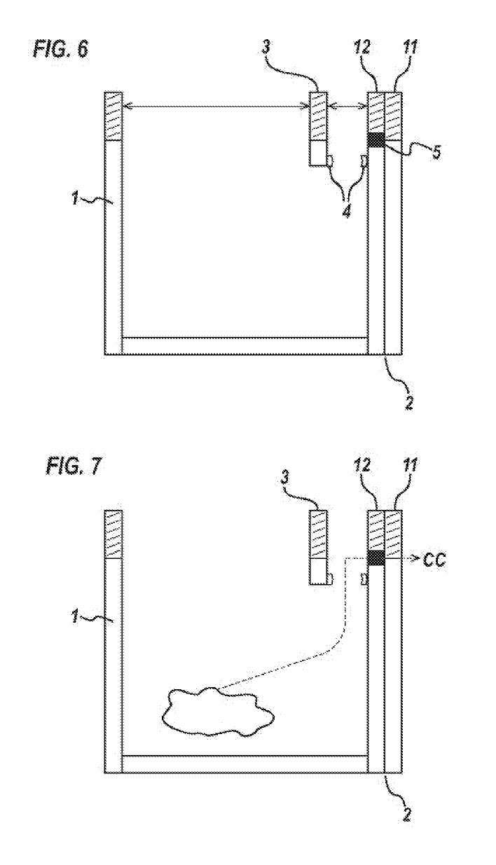

FIG. 6 depicts an example of a filled bag of the present invention according to FIG. 4 and FIG. 5, showing in particular the heat seals applied to a filled bag. Mouth region 7 is closed in the bag of FIG. 6 by the heat sealing shown by the shaded region. Front sheet 2, overlay sheet 3 and back sheet 1 are heat sealed together. At the predetermined temperature used, removable strip 5 is not heat sealed by the same operation to the overlay sheet 3 or to the back sheet 1 or to the adjacent panels of inner layer 12 (although some temporary bonding may occur). The heat sealing of the mouth region 7 shown in FIG. 6 is performed after the filling in of content.

FIG. 7 depicts the bag of FIG. 6 wherein the path CC shows the path along which the content of the filled bag can be accessed through the opened grip seal tape 4 (shown open) after removal of the removable strip 5 (shown intact) and the resulting opening of the outer layer 11 of the front sheet (shown intact). Access to the content can be subsequently and repeatably closed in whole or in part by closing the grip seal tape 4.

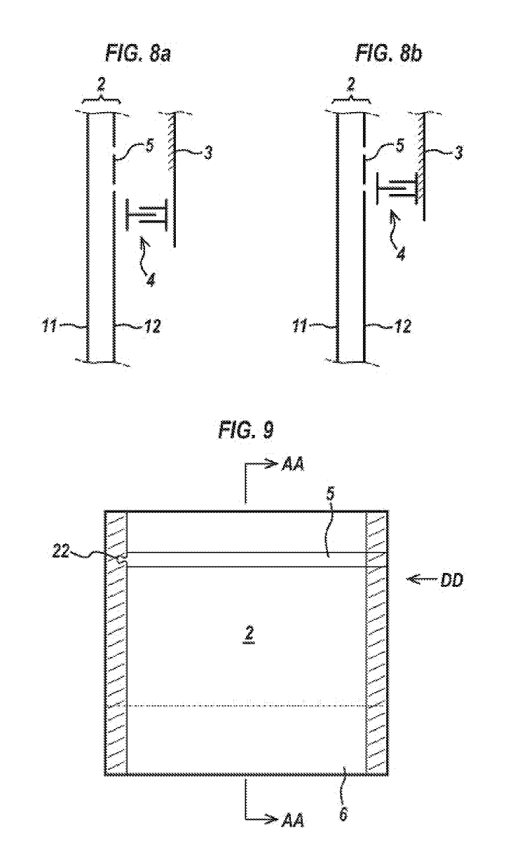

An enlargement of a region of the bag of FIG. 5 of the present invention is depicted in FIG. 8a, which shows in shading the region of overlay sheet 3 which is heat sealed to front sheet 2, relative to the positions of the removable strip 5 and the grip seal tape 4. The strip 5 does not extend past the reseal component 4 and the sealed region does not extend beyond the removable strip 5 so that the content can be accessed through opening the grip seal tape 4. In alternative embodiments where an overlay sheet is not present, overlay sheet 3 in FIG. 8a is replaced by back sheet 1.

An enlargement of a region of an alternative embodiment to the bag depicted in FIG. 5 s shown in FIG. 8b. As in FIG. 8a, FIG. 8b shows in shading the region of overlay sheet which is heat sealed to front sheet 2, relative to the positions of the removable strip 5 and the grip seal tape 4. The position of the removable strip 5 overlaps the reseal component and the sealed region extends beyond the removable strip 5. However, removal of the strip 5 enables access to the reseal component and hence access to the content through opening the reseal component since the heat sealing operation does not seal the grip seal tape 4 closed and the removable strip 5 is not sealed to the reseal component 4. In alternative embodiments where an overlay sheet is not present, overlay sheet 3 in FIG. 8b is replaced by back sheet 1.

An example of a bag of the invention is depicted in FIG. 9, which shows a bag as depicted in FIG. 3 but wherein the grip seal tape is not present.

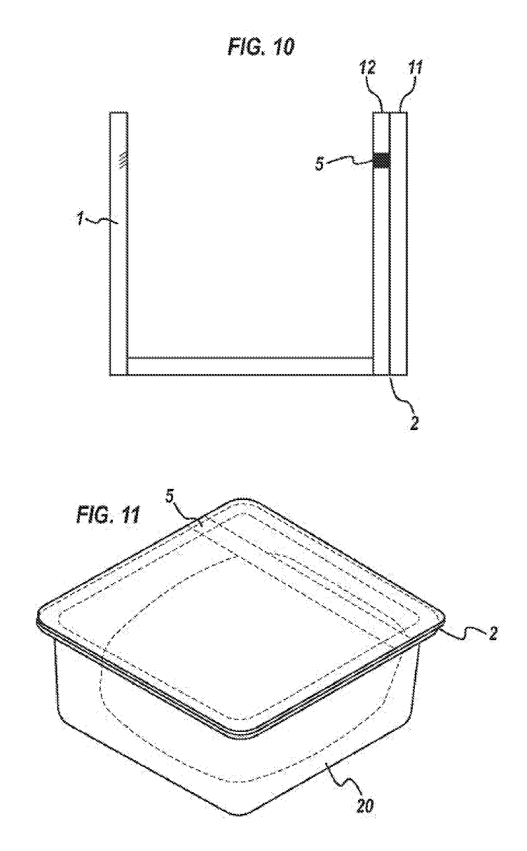

FIG. 10 shows an exploded view of the bag of FIG. 9 in the direction of the line AA, looking from the left of FIG. 3. The laminated front sheet 2 formed from outer layer 11 and inner layer 12 is shown. The region of the back sheet to which the removable strip is temporarily bonded by a peelable heat seal adhesive is shown by a shaded region.

An example of a container to which a front sheet of the invention has been applied is depicted in FIG. 11, which shows front sheet 2 attached to the opening of a container 20 by heat sealing, such that the container is closed by the sheet. The removable strip 5 is indicated under the front sheet by broken lines in the figure.

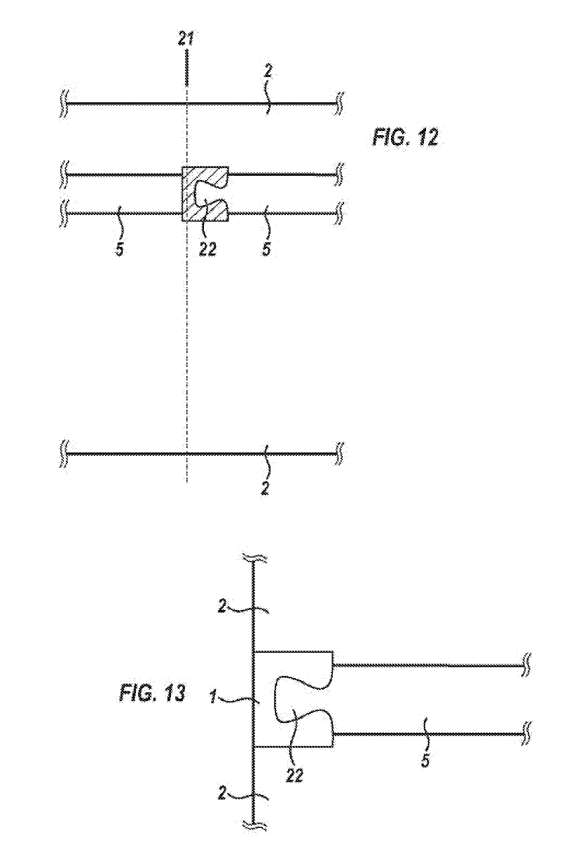

FIG. 12 shows a continuous reel of front sheets 2 wherein an omega shaped-hole, as defined by the shaded region, is formed by punching the front sheet before, or alternatively after, attaching the front sheet to the back sheet or, as the case may be, the overlay sheet. The overlay sheet may be present but is not shown. The reel of front sheets 2 in FIG. 12 may be cut along line 21 to form an edge of a single front sheet which may then be applied to a container or back sheet. The tongue 22 provided allows initial lifting for removal of the strip 5.

FIG. 13 shows an enlargement of the tongue 22 shown in the bags of FIGS. 3 and 9. A portion of the back sheet 1 (or of the overlay sheet 3 if it is present) is visible by virtue of the omega-shaped hole.

FIG. 1 shows a removable strip 5 which may be easily removed from front sheet 2 due to the longitudinal edges abutting the panels of the inner layer 12. The strip 5 may be easily removed through the outer layer 11 to provide an opening in the front sheet 2 through which content such as goods may be accessed if the front sheet is applied to a bag or container.

FIG. 3 shows a bag of the invention which is sealed at the left and right sides of the front sheet 2 and back sheet 1 and sealed by a bottom gusset 6 such that a cavity is defined between the heat seals at the left and right sides, the front sheet 2, the back sheet 1, and gusset 6. Content such as goods may therefore be inserted into the bag from an opening between the front sheet 2 and back sheet 1 at the top of the figure. FIG. 5 shows that such insertion of content may be through an opening between the front sheet 2 and the overlay sheet 3 or the back sheet 1 and the overlay sheet 3. In a preferred embodiment, the opening of a bag of the invention between the front sheet 2 and the overlay sheet 3 is sealed before the bag is filled with content, as depicted in FIG. 5. In a further preferred embodiment, the opening between the front sheet 2 and the overlay sheet 3 is sealed and grip seal tape 4 is closed. Advantageously, the bag may then be filled through route BB between the back sheet 1 and the overlay sheet 3 without the contents contacting the internal surface of strip 5. Moreover, attaching the grip seal tape 4 to the overlay sheet 3 and not the back sheet 1 allows the bag to be filled from the top without opening the grip seal tape 4.

Once a bag of the invention is filled, the opening between the front sheet 2 and the overlay sheet 3 or the back sheet 1 and the overlay sheet 3 may be closed by heat sealing to seal the content such as goods inside the bag. The removal of the strip 5 then enables access to the filled content through opening of the grip seal tape 4. If a temporary bond is present between strip 5 and overlay sheet 3, this bond is breakable on removal of the strip. FIG. 7 shows the path CC along which the content can then be accessed once the strip 5 is removed and grip seal tape 4 opened. The bag remains essentially intact after opening (except for the removal of the removable strip 5 and the resulting opening in front sheet 2) and access to the content can thus be re-closed by closing the grip seal tape 4. For example, if a portion of the content is removed, the remaining content may be resealed in the bag by this closing. Therefore, the grip seal tape 4 serves as a gate to the content of the bag. The presence of a grip seal tape further allows a tongue 22 of the removable strip 5 to be located intermediate of any sides of a bag without leakage.

In an example of a bag or container of the present invention where there is an overlay sheet 3 and a back sheet 1, an advantage of having a grip seal tape 4 between (i.e., having the male and female portions of the grip seal tape 4 attached to) the overlay sheet 3 and the front sheet 2 is that the pressure exerted by the content, especially if the content is fluid such as water, liquid or gas, presses against the grip seal tape 4 thereby making it harder to “open” (or thereby tending to “close”) the grip seal tape 4 hence making the re-closing of the bag (after the removable strip has been removed) more secure when compared with having the grip seal tape 4 between the front sheet 2 and the back sheet 1 without the overlay sheet 3 (in which case the pressure exerted by the content tends to “open” the grip seal tape). This prevents “leakage” of the content after the bag is re-closed by closing the grip seal tape 4 and makes it desirable to use a bag of such structure for purposes of storing fluid or as an air bag. Such a bag is also suitable for use as an air-tight storage bag for storing, for example, clothes or other items, wherein the excess air trapped in the bag can easily be expelled by pressing on the bag. In this case, the close proximity between the overlay sheet 3 and the front sheet 2 tends to block or prevent the expelled air from re-entering the bag while the air is being expelled out from the bag.

In another example of a bag or container of the present invention where an overlay sheet 3 and a back sheet 1 are present, the overlay sheet 3 has a slit 32 or a long narrow opening. The slit 32 is shown as dotted line in FIG. 15 (overlay sheet 3 is behind sheet 2 and not shown in FIG. 15). As shown in FIG. 15, the slit 32 runs substantially parallel to and is located between the longitudinal edges of the removable strip 5.

Preferably, the overlay sheet 3 is bonded to the front sheet 2 except for the region corresponding to which or about which the removable strip 5 is located. For such a bag filled with content, after removal of the removable strip 5 and the resultant opening of the outer and inner layers of the front sheet 2, the content of the bag would become accessible through the opening so formed and also through the slit of the overlay sheet 3. After opening of the bag by removal of the removable strip 5, when the content is not being accessed, the slit remains substantially “closed” so that, for example, any moisture content that remains in the bag will remain substantially “trapped” in the bag without any substantial leakage. Such a bag may for example be used as a bag for storing wet tissue.

A bag of FIGS. 9 and 10 may be filled through access between the front sheet 2 and back sheet 1. Such a bag may be closed in the same manner as the bag depicted in FIG. 6, by heat sealing the front sheet 2 to the back sheet 1.

A container 20 as depicted in FIG. 11 may be filled prior to attachment of the front sheet 2.

FIG. 13 shows a tongue 22 which allows initial lifting for removal of the strip 5 from bags depicted in FIGS. 3 and 9, or other embodiments as appropriate.

The inner and outer layers 12, 11 of the front sheet 2 incorporating a removable strip 5 may be formed as described in U.S. Pat. No. 6,379,760. For example, in FIG. 2 of U.S. Pat. No. 6,379,760, C2 may correspond to a removable strip of the present invention. WO 2009/086604 similarly describes methods in which, before lamination, a strip is continuously removed from a sheet while a replacement strip, which may correspond to a removable strip 5 of the present invention, is continuously fed to fill the gap left by the removal of the strip (see FIG. 1 and FIG. 2 of WO 2009/086604). The removable strip used in the present invention may be formed by the method that replacement strip 26 shown in FIG. 3 of WO 2009/086604 is formed.

In the present invention, the removable strip 5 used is easily removable since the strip abuts on either of its longitudinal sides another panel, the abutting lines enabling easy lifting of the strip. A prior art easy-tear concept is discussed in U.S. Pat. No. 6,610,338 (see FIG. 6(a)).

The removable strip 5 is not bonded to the overlay sheet 3 during heat sealing operations. When the top part of a back sheet 1 in, for example, the bag of FIG. 5, is heat sealed to the front sheet 2, or to close a mouth region, or when the left and right side edges of a bag are sealed at a predetermined temperature, the removable strip 5 is not heat bonded to the overlay sheet 3 or to the back sheet 1. This is due to the fact that the sealing temperature for the said heat sealing operations is not sufficient to bond the material making up the removable strip 5 to the material which the removable strip faces. This concept of differential bonding temperature is discussed in U.S. Pat. No. 6,582,123 and employed to form a vent at the edge for a microwave bag (see column 5, line 45 to column 6, line 9 of U.S. Pat. No. 6,582,123). WO 2009/086604 provides a further discussion of differential heat bonding at page 14, line 20 to page 16, line 11.

U.S. Pat. No. 6,379,760, WO 2009/086604, and U.S. Pat. No. 6,582,123 are hereby incorporated by way of reference.

In the present invention, the differential bonding temperature enables the removable strip 5 to not bond to its opposing surface, thereby allowing its removal (although some temporary bonding which allows removal may occur). For example, a CPP inner layer 12 of the front sheet 2 may be heat sealed with the opposing CPP outer layer 15 of the overlay sheet 3, whereas the removable strip (Aluminium foil or PET) would not be heat sealed to the CPP overlay sheet 3. At the sealing temperature, the CPP layers are sealed to each other, whereas the PET (or aluminium foil) is not sealed (though there may still be some degree of temporary bonding) to the CPP. In this example, the removable strip is also not bonded to the adjacent (CPP) panels of the inner layer 12. An advantage of using aluminium foil for the removable strip 5 is that the removable strip 5 is not easily broken when it is being lifted and removed from the front sheet 2.

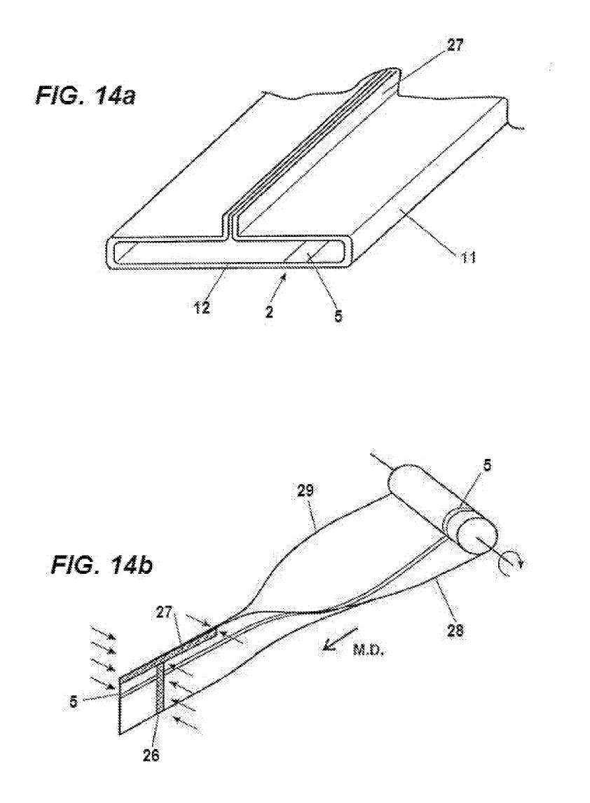

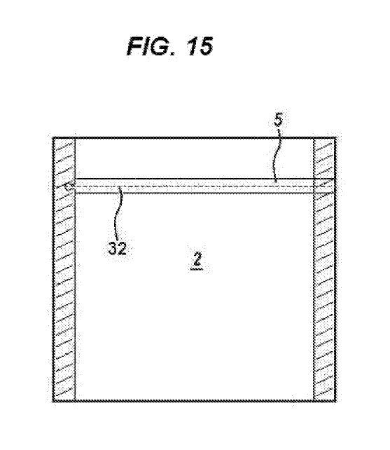

It will be appreciated that in the present invention, the terms “front sheet” and “back sheet” are not limited to being referring to separate sheets of material. The terms “front sheet” and “back sheet” can in fact be referring to the front part and the back part respectively of a single sheet of material which comprises a removable strip 5 and which, for example, is folded into a bag. An example of a bag of the present invention wherein the front sheet and the back sheet are simply the front and back parts of a folded single sheet comprising a removable strip 5 is as shown in FIG. 14a. Such a bag may for example be formed, as shown in FIG. 14b, by bringing together the longitudinal edges 28, 29 of a lay-flat sheet of material and heat sealing along the longitudinal edges 28, 29 to form a seal 27 of the tube, followed by heat sealing and cutting to define a bottom edge 26 of the bag.

It will of course also be understood that the present invention has been described above purely by way of examples and modifications of detail can be made within the scope of the invention.

1. A front sheet for packaging, the front sheet comprising a laminate of an inner layer and an outer layer relative to the interior of the packaging;
said inner layer incorporating a removable strip having longitudinal edges abutting adjacent panels of the inner layer;
arranged such that removal of said removable strip forms an opening through the inner and outer layers of said front sheet,
wherein an overlay sheet overlays and is substantially in contact with the removable strip.

2. A front sheet according to claim 1, wherein said overlay sheet and said front sheet are heat sealable together at a temperature, and at said temperature said removable strip does not heat seal to said overlay sheet or said adjacent panels.

3. A front sheet according to claim 1, further comprising a reseal component, wherein a first part of said reseal component is attached to said front sheet and a second part of said reseal component is attached to said overlay sheet.

4. A front sheet according to claim 3, wherein the reseal component comprises a grip seal tape.

5. A front sheet according to claim 1, wherein the removable strip comprises a tongue for facilitating lifting of the removable strip; and
wherein said tongue is formed by a cut through the front sheet.

6. A front sheet according to claim 1, wherein the overlay sheet is perforated.

7. A front sheet according to claim 1, wherein the overlay sheet has a slit.

8. A front sheet according to claim 7, wherein the slit runs substantially parallel to the longitudinal edges of the removable strip.

9. A front sheet according to claim 7, wherein the overlay sheet is laminated to the front sheet except at least for the region where the removable strip is located.

10. A front sheet according to claim 1, wherein the removable strip is multilayered and comprises a metallic foil layer and one or more other layers comprising one or more materials selected from: polyethylene terephthalate, nylon and oriented polypropylene.

11. A front sheet according to claim 1, wherein said removable strip comprises aluminium foil.

12. A front sheet according to claim 1, wherein the thickness of the panels of the inner layer which abut the removable strip is greater than or equal to the thickness of the removable strip.

13. A front sheet according to claim 1, wherein said outer layer of said front sheet is provided with one or more lines of weakness adapted to facilitate tearing of said front sheet along one or more lines corresponding to the edges of the removable strip when the removable strip is removed, wherein said one or more lines of weakness are formed by one or more indentations, one or more broken lines or one or more lines of perforations in said outer layer.

14. A bag comprising a front sheet according to claim 1, and further comprising a back sheet wherein the front sheet and the back sheet define a bag having an internal cavity between the front sheet and the back sheet and a content opening.

15. A bag according to claim 14, wherein said removable strip extends across the front sheet from an attached region of a side of the sheet to a further attached region of another side of the sheet.

16. A container comprising a front sheet, the front sheet comprising a laminate of an inner layer and an outer layer relative to the interior of the container;
said inner layer incorporating a removable strip having longitudinal edges abutting adjacent panels of the inner layer;
arranged such that removal of said removable strip forms an opening through the inner and outer layers of said front sheet,
wherein an inner surface of the removable strip is temporarily bonded to a further component of the container, such that the bond is broken on removal of said removable strip.

17. A container according to claim 16, further comprising a back sheet wherein the front sheet and the back sheet define a bag comprising an internal cavity between the front sheet and the back sheet, and a content opening.

18. A container according to claim 16, further comprising a back sheet wherein the front sheet and the back sheet define a bag comprising an internal cavity between the front sheet and the back sheet, and a content opening; and wherein an overlay sheet overlays and is temporarily bonded to said removable strip.

19. A container according to claim 18, wherein the overlay sheet has a slit through which the internal cavity is accessible after removal of said removable strip.

20. A container according to claim 18, wherein the overlay sheet is laminated to the front sheet except at least for the region where the removable strip is located.

21. A container according to claim 16, wherein the front sheet is attached to and closes a box.

22. A bag comprising a front sheet, the front sheet comprising a laminate of an inner layer and an outer layer relative to the interior of the container;
said inner layer incorporating a removable strip having longitudinal edges abutting adjacent panels of the inner layer;
arranged such that removal of said removable strip forms an opening through the inner and outer layers of said front sheet;
further comprising a back sheet, and an overlay sheet arranged between said front sheet and said back sheet;
wherein the front sheet and the back sheet define a bag having an internal cavity between the front sheet and the back sheet, which is accessible between the overlay sheet and the back sheet, and between the overlay sheet and the front sheet.

23. A bag according to claim 22, wherein the back sheet, the overlay sheet and the front sheet are heat sealable together at a temperature to seal said bag, and at said temperature the removable strip does not heat seal to said overlay sheet or said adjacent panels.

24. A bag according to claim 22, further comprising a reseal component arranged to close resealably an opening between the overlay sheet and the front sheet, wherein a first part of said reseal component is attached to the front sheet and a second part of said reseal component is attached to the overlay sheet.

25. A bag according to claim 22, wherein the overlay sheet has a slit through which the content of the bag is accessible after removal of the removable strip.

26. A bag according to claim 22, wherein the overlay sheet is laminated to the front sheet except at least for the region where the removable strip is located.

27. A bag according to claim 22, wherein said removable strip extends across the front sheet from an attached region of a side of the sheet to a further attached region of another side of the sheet.

28. Use, in a method of sealing a container, of a front sheet as defined in claim 1.
